(19) United States
(12) Patent Application Publication
(10) Pub. No.: US 2024/0290993 A1
(43) Pub. Date: Aug. 29, 2024

(54) A SEPARATOR ELEMENT ARRANGEMENT FOR AN ELECTROCHEMICAL CELL COMPRISING A NANOSTRUCTURE

(71) Applicant: SMOLTEK AB, GÖTEBORG (SE)

(72) Inventors: Rickard Andersson, GÖTEBORG (SE); Maria Bylund, GÖTEBORG (SE); Vincent Desmaris, GÖTEBORG (SE); Qi Li, GÖTEBORG (SE); Victor Marknäs, MÖLNDAL (SE); Elisa Passalacqua, GÖTEBORG (SE); Muhammad Amin Saleem, GÖTEBORG (SE); Fabian Wenger, GÖTEBORG (SE); Simin Zare, Kungälv (SE)

(21) Appl. No.: 18/569,299

(22) PCT Filed: Jun. 27, 2022
(86) PCT No.: PCT/EP2022/067600

§ 371 Date: Dec. 12, 2023

(30) Foreign Application Priority Data
Jul. 9, 2021 (SE) 2130192-4

(51) Int. Cl. H01M 8/0234; B82Y 30/00; B82Y 40/00; C25B 13/02; C25B 13/05; H01M 8/0245; H01M 8/0258

(52) U.S. Cl. CPC H01M 8/0234; B82Y 40/00; C25B 13/02; C25B 13/05; H01M 8/0245; H01M 8/0258; B82Y 30/00

(57) ABSTRACT

A separator element arrangement for an electrochemical cell is presented. The separator element arrangement comprises a separator element and a diffusion layer arranged adjacent to the separator element. The separator element comprises a plurality of elongated nanostructures. At least some of the elongated nanostructures are arranged to connect the separator element to the diffusion layer by extending into the diffusion layer.

### TECHNICAL FIELD

The present disclosure relates to separator elements and separator element arrangements suitable for electrochemical cells such as fuel cells and electrolyzers.

### BACKGROUND

Electrochemical cells such as batteries, fuel cells, and electrolyzers are finding widespread application in modern energy systems. The production of hydrogen gas through the electrolysis of water is a promising technology both for replacing the production of hydrogen gas from fossil fuels and as a means of converting excess electrical energy from intermittent energy sources such as solar and wind power to chemical energy for storage. Fuel cells, meanwhile, are an attractive technology for the conversion of chemical energy into electrical energy, partly due to their high efficiency compared to e.g., internal combustion engines and partly due to that they can easily use environmentally friendly fuels such as sustainably produced hydrogen gas.

However, existing electrochemical cells suffer from high contact resistance between different components of the cell, which leads to lower efficiency. The problem may be exacerbated by the formation of non-conducting surface layers on some components due to the chemical environment of the cell.

WO 2019/186047 A1 discloses a component for an electrochemical cell with a reduced contact resistance.

Still, electrochemical cells with components showing lower contact resistance are needed.

### SUMMARY

It is an object of the present disclosure to provide an improved separator element arrangement for an electrochemical cell, which, i.a., offers lowered contact resistance between a separator element and a diffusion layer.

This object is at least in part obtained by a separator element arrangement for an electrochemical cell. The separator element arrangement comprises a separator element and a diffusion layer arranged adjacent to the separator element. The separator element comprises a plurality of elongated nanostructures, at least some of the elongated nanostructures being arranged to connect the separator element to the diffusion layer by extending into the diffusion layer.

At least some of elongated nanostructures extending into the diffusion layer means that some of the nanostructures pass beyond a surface of the diffusion layer that is facing the separator element, e.g., by extending into holes or grooves on the surface of the diffusion layer. The elongated nanostructures are thus placed in direct contact with the diffusion layer, which improves the mechanical and electrical contact between the diffusion layer and the separator element. This is especially if the elongated nanostructures comprise an electrically conducting material, that is, a material with an electrical conductivity similar to that of a metal or semiconductor.

Put another way, the separator element arrangement comprises a separator element and a diffusion layer arranged adjacent to the separator element. The separator element arrangement also comprises a plurality of elongated nanostructures attached to a surface of the separator element facing the diffusion layer. At least some of the elongated nanostructures are arranged to connect the separator element to the diffusion layer by extending into the diffusion layer.

The separator element may be a planar element or a separator plate. Likewise, the diffusion layer may be a planar element or planar structure. This facilitates the assembly of the separator element arrangement and the incorporation of the separator element arrangement into an electrochemical cell.

The plurality of elongated nanostructures may comprise elongated carbon nanostructures. Advantageously, carbon nanostructures display good electrical conductivity and adequate chemical stability for use in many electrochemical cells. In particular, the elongated carbon nanostructures may comprise any of carbon nanofibers, carbon nanowires, and carbon nanotubes. The properties, such as density and shape, of carbon nanofibers, nanowires, and nanotubes can easily be adjusted by altering the conditions under which the nanofibers, nanowires, and nanotubes are produced. Carbon nanofibers and nanowires are also mechanically rigid, making it easier to maintain their orientation relative to the separator element during assembly of the separator element arrangement.

The plurality of elongated nanostructures may also comprise elongated metallic nanostructures. Metallic nanostructures will also display high electrical conductivity and good mechanical stability and rigidity.

According to aspects, at least some of the elongated nanostructures may be oriented in parallel to each other and extend along a direction perpendicular to a plane of extension of the separator element. This means that the elongated nanostructures have similar orientations and form a nanostructure forest, extending generally perpendicularly from the extension plane of the separator element. The largely uniform orientation of the elongated nanostructures facilitates assembly of the separator element arrangement. That the nanostructures are oriented generally perpendicularly to the plane of extension of the separator element facilitates ensuring that the nanostructures do in fact extend into the diffusion layer and controlling how far into the diffusion layer they extend.

According to other aspects, at least some of the elongated nanostructures may be oriented at an angle of between 10 and 80 degrees to the extension plane of the separator element.

The desired length of the elongated nanostructures may depend on, i.a., the properties of the diffusion layer. In particular, when the diffusion layer comprises a porous material, the desired length of the elongated nanostructures may depend on the structure of said porous material. According to aspects, the length of at least one of the elongated nanostructures measured along an axis extending perpendicularly to a plane of extension of the separator element may be between 10 and 20 micrometers. According to other aspects, the length of at least one of the elongated nanostructures in the dimension in which it is largest may be between 10 and 20 micrometers.

The separator element may comprise a flow field arrangement, the flow field arrangement being arranged on a surface of the separator element facing the diffusion layer, the flow field arrangement comprising a plurality of flow channels separated by a plurality of channel supports. The flow channels may be arranged to promote an even distribution of a gas and/or a liquid across the flow field arrangement. Advantageously, an even distribution of a gas and/or liquid across the flow field arrangement leads to an even distribution of the reactants of the electrochemical reactions in the electrochemical cell, leading to a more efficient use of the whole area of the cell.

If the separator element comprises a flow field arrangement, the plurality of elongated nanostructures may be connected to a surface of at least one of the channel supports of the flow field arrangement, where the surface faces the diffusion layer. The channel supports form elevated ridges on the separator element surface, which means that the channel supports will be in closer contact with the diffusion layer. Having the nanostructures arranged only on the channel supports, and preferably on the top of the channel supports, is therefore an advantage.

The separator element may also comprise a protective coating arranged to increase a resistance to corrosion. A protective coating may shield the material of the separator element from the chemical environment of the electrochemical cell and prevent degradation.

According to aspects, the diffusion layer comprises a porous carbon material. The porous carbon material may comprise a plurality of carbon fibers, and the plurality of carbon fibers may extend generally parallel to a plane of extension of the separator element and/or generally perpendicularly to the plurality of elongated nanostructures. Carbon materials are suitable for use in diffusion layers due to their electrical conductivity and chemical stability. Advantageously, a porous carbon material can also allow for efficient transport of reactants and products through the electrochemical cell.

The object is also obtained at least in part by a method for producing a separator element arrangement. The separator element arrangement comprises a separator element and a diffusion layer arranged adjacent to the separator element. The method comprises generating a plurality of elongated nanostructures, where the elongated nanostructures are connected to a surface of the separator element. The method also comprises arranging the diffusion layer adjacent to the separator element such that the elongated nanostructures connect the separator element to the diffusion layer by extending into the diffusion layer.

By extending into the diffusion layer, the elongated nanostructures are placed in direct contact with the diffusion layer, which improves the mechanical and electrical contact between the diffusion layer and the separator element. This is especially the case if the elongated nanostructures comprise an electrically conducting material, that is, a material with an electrical conductivity similar to that of a metal or semiconductor.

Generating a plurality of elongated nanostructures may comprise growing the elongated nanostructures on a substrate. Advantageously, growing the elongated nanostructures on a substrate makes it possible to tailor the properties and shape of the nanostructures by tuning the conditions under which the nanostructures are grown, e.g., to improve the mechanical and electrical contact between the nanostructures and the diffusion layer. For example, the thickness of the elongated nanostructures may be tuned to improve structural stability.

Advantageously, if the substrate comprises a separator element arranged so that the nanostructures are grown on the separator element, this establishes a chemical bond between the nanostructures and the surface and contributes to good electrical contact and low contact resistance between the elongated nanostructures and the separator element.

Growing the elongated nanostructures on a substrate may comprise depositing a growth catalyst layer on a surface of the substrate and growing the elongated nanostructures on the growth catalyst layer. The growth catalyst layer promotes growth of the elongated nanostructures. By altering the properties of the growth catalyst layer, the properties of the grown elongated nanostructures can be tuned in order to improve the functionality of the separator element arrangement.

Depositing a growth catalyst layer may comprise depositing a uniform growth catalyst layer and introducing a pattern onto the deposited uniform growth catalyst layer. An advantage of introducing a pattern onto the deposited uniform growth catalyst layer is that it makes it possible to control the number of nanostructures per surface area on the substrate. The number of nanostructures per surface area may for example be adapted to the structure of the diffusion layer, to improve electrical and mechanical contact between the nanostructures and the diffusion layer.

The method may also comprise depositing a conducting layer on a surface of the substrate. Advantageously, depositing a conducting layer on the surface of the substrate can produce the effect of electrically grounding the substrate. Electrically grounding the substrate may be advantageous for certain methods of growing nanostructures. If a conductive layer is deposited on a surface of the substrate and a growth catalyst layer is deposited on top of the conductive layer, the conductive layer may also hinder cross-diffusion of atoms and/or molecules between the catalyst layer and the substrate.

The method may further comprise coating the separator element at least partly with a protective coating arranged to increase a resistance to corrosion. A protective coating may shield the material of the separator element from the chemical environment of the electrochemical cell and prevent degradation.

There is also herein disclosed a fuel cell comprising an ion exchange membrane, a first electrocatalyst layer, and a second electrocatalyst layer. The first and second electrocatalyst layers are arranged adjacent to the ion exchange membrane on either side of the ion exchange membrane. The fuel cell further comprises a first separator element arrangement and a second separator element arrangement arranged adjacent to the respective first and second electrocatalyst layers on the side of the respective electrocatalyst layer facing away from the ion exchange membrane. Each separator element arrangement comprises a separator element and a diffusion layer arranged adjacent to the separator element.

At least one of the separator element arrangements is a separator element arrangement as previously described. That is, the separator element arrangement comprises a plurality of elongated nanostructures attached to a surface of the separator element. The surface is a surface facing the diffusion layer. At least some of the elongated nanostructures are arranged to connect the separator element to the diffusion layer by extending into the diffusion layer. This separator element arrangement is associated with all advantages described above. When the separator element arrangement is arranged in a fuel cell, there is the additional advantage of providing a fuel cell with lower contact resistance between the separator element and the diffusion layer of the separator element arrangement, which improves the fuel cell efficiency.

Furthermore, there is herein disclosed a fuel cell stack comprising at least one fuel cell as herein described.

There is also disclosed an electrolyzer comprising an ion exchange membrane, a first electrocatalyst layer, and a second electrocatalyst layer, the first and second electrocatalyst layers being arranged adjacent to the ion exchange membrane on either side of the ion exchange membrane. The electrolyzer further comprises a first separator element arrangement and a second separator element arrangement arranged adjacent to the respective first and second electrocatalyst layers on the side of the respective electrocatalyst layer facing away from the ion exchange membrane. Each separator element arrangement comprises a separator element and a diffusion layer arranged adjacent to the separator element.

At least one of the separator element arrangements is a separator element arrangement as herein described. That is, the separator element arrangement comprises a plurality of elongated nanostructures attached to the separator element, at least some of the elongated nanostructures being arranged to connect the separator element to the diffusion layer by extending into the diffusion layer. This separator element arrangement is associated with all advantages described above. When the separator element arrangement is arranged in an electrolyzer, there is the additional advantage of providing an electrolyzer with lower contact resistance between the separator element and the diffusion layer of the separator element arrangement, which improves the efficiency of the electrolyzer.

Also, there is disclosed an electrolyzer stack comprising at least one electrolyzer as described above.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where:

FIG. 1 schematically illustrates a fuel cell;

FIG. 2 schematically illustrates an electrolyzer;

FIG. 3 schematically illustrates a separator element arrangement;

FIGS. 4A, B and C schematically illustrate a flow field arrangement;

FIG. 5 illustrates a fuel cell stack; and

FIG. 6 is a flow chart illustrating methods.

### DETAILED DESCRIPTION

Aspects of the present disclosure will now be described more fully with reference to the accompanying drawings. The different devices and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

The following description is focused on two types of electrochemical cells, namely fuel cells and electrolyzers. In particular, it deals with fuel cells and electrolyzers that comprise a proton exchange membrane and use hydrogen gas as a fuel or produce hydrogen gas from water, respectively. However, a person skilled in the art will realize that the devices and methods herein described can also be used in other types of electrochemical cells. The disclosure is also applicable to other types of fuel cells, e.g., fuel cells that use methanol as a fuel, and other types of electrolyzers. In particular, the disclosure is applicable to fuel cells and electrolyzers wherein another type of solid electrolyte, such as an anion exchange membrane, is used in place of a proton exchange membrane.

In a fuel cell, chemical energy from a fuel is converted into electrical energy through reduction and oxidation reactions. A fuel cell comprises two electrodes, and an electrolyte that allows ions to travel between the electrodes. The electrodes are also electrically connected to an electric load, where the generated electrical energy is used.

The fuel cell electrolyte must simultaneously be a good ionic conductor, i.e., be able to transport ions, and a poor electronic conductor, i.e., hinder the transport of electrons. Fuel cell electrolytes may be liquids, such as liquid solutions of alkaline salts or molten carbonate compounds, or solids such as polymer membranes or metal oxides. Examples of polymer membrane materials are sulfonated tetrafluoroethylene, also known as Nafion, and polymers based on polysulfone or polyphenole oxide. Ion-conducting metal oxides may be e.g., doped barium zirconate, doped barium cerate, doped lanthanum gallate, or stabilized zirconia. Different electrolytes may be suitable for conducting different types of ions. For example, sulfonated tetrafluoroethylene-based membranes such as Nafion can conduct hydrogen ions, i.e., protons, and are therefore known as proton exchange membranes or PEM. Many metal oxides are suitable for conducting oxygen ions.

Fuel cells that use ion exchange membranes such as Nafion are often referred to as proton exchange membrane fuel cells or PEMFC, since the membrane conducts protons. In PEMFC, a hydrogen-containing fuel such as hydrogen gas is introduced at the first electrode, the anode, while an oxygen-containing gas is introduced at the second electrode, the cathode. At the anode, the hydrogen is split into protons and electrons with the aid of an electrocatalyst. This is referred to as the hydrogen oxidation reaction. The protons traverse the ion exchange membrane to the cathode, while electrons traverse the electrical connection between the anode and the cathode, where the generated electrical energy can be put to use. At the cathode, protons and electrons react with oxygen through the oxygen reduction reaction to form water. This reaction is also aided by an electrocatalyst.

A catalyst is a material or chemical compound that facilitates a chemical reaction, e.g., by lowering the amount of energy needed to start the chemical reaction. An electrocatalyst is a catalyst used in an electrochemical reaction such as the hydrogen oxidation and oxygen reduction reactions taking place in a fuel cell. Fuel cell electrocatalysts frequently comprise noble metals such as platinum, ruthenium, or palladium.

In PEMFC and other fuel cells using solid ion conductors, the anode and cathode catalysts are often arranged as electrocatalyst layers on opposite surfaces of the ion exchange membrane. For PEMFC in particular, the electrocatalyst layers often comprise an electrocatalyst material such as platinum in the form of nanoparticles, that is, particles with a diameter that is substantially smaller than one micrometer and mostly between 1 and 100 nm. The electrocatalyst layer typically also comprises a catalyst binder or support, often comprising carbon nanomaterials such as carbon nanoparticles or nanotubes, or carbon black. The electrocatalyst layer may also comprise an ionically conductive polymer, arranged to facilitate transport of hydrogen ions to the ion exchange membrane, and hydrophobic materials such as Teflon. According to aspects, a catalyst layer may be between 5 and 50 nm thick. According to other aspects, the thickness of the catalyst layer may depend on the type of catalyst used.

An ion exchange membrane with an anode electrocatalyst layer and a cathode electrocatalyst layer arranged on opposite surfaces is sometimes referred to as a membrane electrode assembly.

In order for the fuel cell to operate, ions and electrons must be able to travel from the anode-side electrocatalyst, through the ion exchange membrane and the electric load respectively, and reach the cathode-side electrocatalyst. In addition, reactant gases such as hydrogen and oxygen gas must be able to reach the electrocatalyst layers, while the product, water, must be continually removed from the cell. In most PEMFC, this is accomplished by arranging a porous diffusion layer comprising an electrically conductive material next to each electrocatalyst layer, and a separator element also comprising a conductive material next to each diffusion layer. Herein, the combination of porous diffusion layer and separator element is referred to as a separator element arrangement.

A conductive material, element, or component is here taken to be a material, element, or component that has a high electric conductivity. A high electric conductivity could be an electric conductivity normally associated with metallic or semiconducting materials, or an electric conductivity of more than 100 Sm⁻¹.

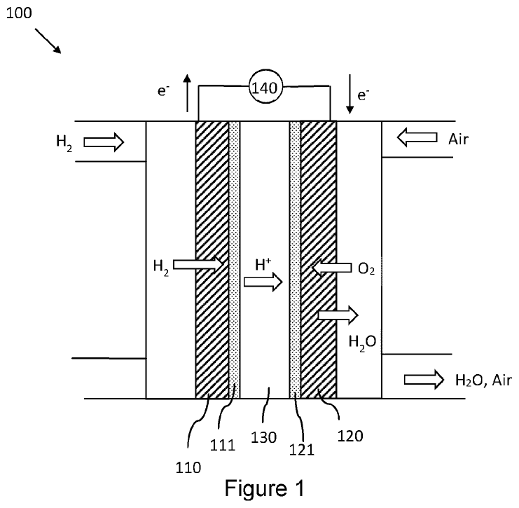

FIG. 1 shows a fuel cell 100 comprising an ion exchange membrane 130, a first electrocatalyst layer 111 and a second electrocatalyst layer 121. The first and second electrocatalyst layers 111, 121 are arranged adjacent to the ion exchange membrane on either side of the ion exchange membrane. A first separator element arrangement 110 and a second separator element arrangement 120 are arranged adjacent to the respective first and second electrocatalyst layer on the side of the electrocatalyst layer facing away from the ion exchange membrane 130. Each separator element arrangement comprises a diffusion layer and a separator element. In the fuel cell, each separator element arrangement is arranged such that the diffusion layer is sandwiched between the respective electrocatalyst layer and the separator element comprised in the separator element arrangement. The two separator element arrangements are electrically connected through the load 140.

The porous diffusion layer, which may also be referred to as a current collector or a mass transport layer, is arranged to allow reactants and products such as hydrogen gas, oxygen gas, and water to be transported through the pores of the diffusion layer, while still maintaining electrical contact between the electrocatalyst layer and the separator element. It often comprises porous electrically conducting materials such as metal foams, porous carbon, or carbon paper. The diffusion layer may also provide structural support for the electrocatalyst layers 111, 121 and ion exchange membrane 130.

The separator element often comprises metallic materials such as steel and/or other electrically conducting materials such as carbon composites. It is the component that is connected to the electrical load, as well as separating the fuel cell from its surroundings. If the fuel cell forms part of a fuel cell stack, a separator element may form part of the cathode side of one fuel cell and the anode side of an adjacent fuel cell, in which case it may be referred to as a bipolar plate. Other possible terms are separator plate or flow plate.

For efficient fuel cell operation, it is important to minimize the electrical contact resistance between the elements of the fuel cell, that is, the electrical resistance associated with the interfaces between e.g., a separator element and the adjacent diffusion layer or a diffusion layer and the adjacent electrocatalyst layer. However, higher contact resistance sometimes develops between a separator element and the adjacent diffusion layer, for example as a result of insufficient physical contact between the two components. The issue may be exacerbated by the formation of compounds that are not electrically conductive, such as metal oxides, on the surface of the separator element.

Water electrolyzers, meanwhile, use electrical energy to split water into oxygen gas and hydrogen gas. Electrolyzers may normally comprise the same components as described above for fuel cells. In particular, they comprise an ion-conducting electrolyte and two electrodes, a cathode and an anode. The cathode and anode are electrically connected to a power source. Proton exchange membranes such as Nafion can be used as electrolytes in electrolyzers as well as in fuel cells, as can the other abovementioned polymer membranes and solid oxide ionic conductors. Liquid electrolytes comprising an alkaline solution may also be used.

In an electrolyzer comprising a proton-conducting electrolyte such as a PEM, water will be introduced at the anode side and split into oxygen and hydrogen in what is known as the oxygen evolution reaction. The oxygen will form oxygen gas while the hydrogen is split into protons, which will subsequently traverse the ion exchange membrane and reach the cathode, and electrons which travel to the cathode via the power source. At the cathode protons and electrons form hydrogen gas through the hydrogen evolution reaction.

The electrocatalysts used in electrolyzers may differ from those used in fuel cells. In electrolyzers using PEM electrolytes, the anode-side electrocatalyst often comprises iridium oxide, while the cathode-side electrocatalyst generally comprises platinum or other platinum-group metals. In electrolyzers using an anion exchange membrane, AEM, electrolyte, both electrocatalysts may instead comprise materials such as nickel or cobalt.

In electrolyzers that comprise solid electrolytes such as PEM and AEM the anode and cathode electrocatalysts are often arranged in electrocatalyst layers on opposite sides of the electrolyte membrane to form a membrane electrode assembly, as previously described for fuel cells. One or both electrocatalysts may be in the form of nanoparticles. In addition to the electrocatalyst itself, the electrocatalyst layer may comprise a catalyst support such as carbon black, carbon nanotubes, or a metal foam.

The electrocatalyst layer may also comprise an ionically conducting polymer and hydrophobic materials such as Teflon.

The requirements on ion transport through the electrolyte, mass transport of reactants and products to and from the electrocatalyst, and good electrical contact between the elements in the cell are the same in an electrolyzer as in a fuel cell. Therefore, electrolyzers are also often equipped with porous diffusion layers arranged adjacent to each electrocatalyst layer and separator elements arranged adjacent to each diffusion layer. The diffusion layers may comprise porous carbon materials, metal foams, or metal meshes, often comprising titanium. The separator plates may for example comprise metallic materials such as steel or titanium, or electrically conducting carbon composites.

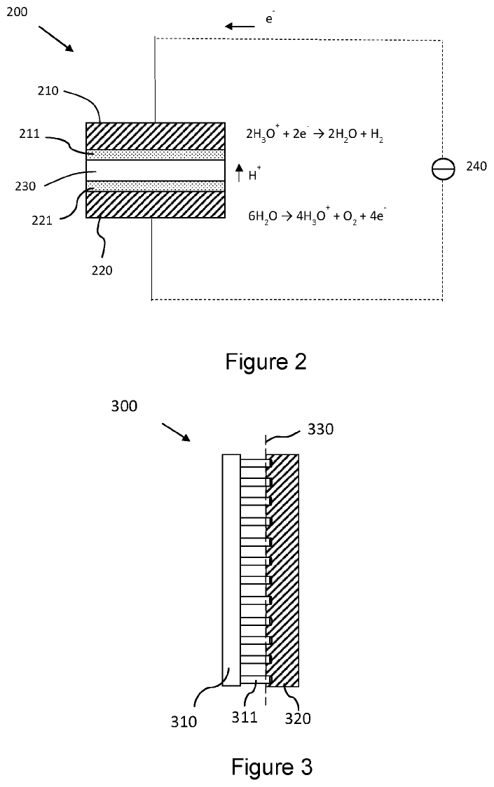

FIG. 2 shows an electrolyzer 200 comprising an ion exchange membrane 230, a first electrocatalyst layer 211 and a second electrocatalyst layer 221. The first and second electrocatalyst layers are arranged adjacent to the ion exchange membrane 230 on either side of the ion exchange membrane. A first separator element arrangement 210 and a second separator element arrangement 220 are arranged adjacent to the first and second electrocatalyst layer on the side of the electrocatalyst layer facing away from the ion exchange membrane 230. Each separator element arrangement comprises a diffusion layer and a separator element. When arranged in the electrolyzer, each separator element arrangement is placed such that the diffusion layer is sandwiched between the separator element and the respective electrocatalyst layer. Both separator element arrangements are connected to a power source 240.

In both fuel cells and electrolyzers, the contact resistance between components may be reduced if better mechanical contact between the components is established. FIG. 3 shows a separator element arrangement 300 for an electrochemical cell, with improved mechanical contact and reduced contact resistance between the separator element and the diffusion layer. The separator element arrangement 300 comprises a separator element 310 and a diffusion layer 320 arranged adjacent to the separator element 310. The separator element comprises a plurality of elongated nanostructures 311, at least some of the elongated nanostructures being arranged to connect the separator element 310 to the diffusion layer 320 by extending into the diffusion layer.

A nanostructure is a structure having a size that is substantially smaller than one micrometer, and preferably between 1 and 100 nm, in at least one dimension. Herein, an elongated nanostructure is a nanostructure that is substantially larger in at least one dimension, such as length, compared to another dimension such as width or depth. As an example, consider a substantially cylindrical nanostructure characterized by a length and a diameter. The nanostructure may be considered elongated if the length is significantly larger than the diameter, e.g., if the length is more than twice as large as the diameter. Similar reasoning may be applied to nanostructures that are substantially conical, frustoconical, rectangular, or of arbitrary shape.

The elongated nanostructures 311 may for example be straight, spiraling, branched, wavy or tilted. Optionally, they are classifiable as nanowires, nano-horns, nanotubes, nano-walls, crystalline nanostructures, or amorphous nanostructures.

Preferably, the elongated nanostructures 311 comprise an electrically conducting material.

In general, the elongated nanostructures 311 comprised in the separator element 310 are attached to a surface of the separator element 310 that is facing the diffusion layer 320. The elongated nanostructures 311 may be attached to the surface of the separator element 310 e.g., by a chemical bond, by an adhesive, or by some other attachment means. According to aspects, the elongated nanostructures 311 may have been grown on the surface of the separator element 310. In which case, they may have a strong chemical bond to the surface. Preferably, the elongated nanostructures should be attached to the surface in a way that leads to low contact resistance between the nanostructures and the surface.

That at least some nanostructures in the plurality of elongated nanostructures 311 extends into the diffusion layer 320 is taken to mean that at least some of the plurality of elongated nanostructures passes beyond a surface of the diffusion layer facing the separator element 310. In FIG. 3, this surface is indicated by the dashed line 330. If the surface is not planar, e.g., if it is curved or uneven, a nanostructure may be taken to extend into the diffusion layer if it passes beyond a tangent of the surface at the point where the surface is closest to the nanostructure.

Put another way, the separator element arrangement 300 comprises a separator element 310 and a diffusion layer 320 arranged adjacent to the separator element 310. The separator element arrangement 300 also comprises a plurality of elongated nanostructures 311 arranged attached to a surface of the separator element 310 facing the diffusion layer 320. At least some of the elongated nanostructures are arranged to connect the separator element 310 to the diffusion layer 320 by extending into the diffusion layer.

The diffusion layer 320 will generally comprise porous materials, that is, materials comprising a plurality of voids, holes, or pores. Some pores will intersect with surfaces of the material, creating pits or grooves in said surface. It is then possible for elongated nanostructures comprised in the separator element to extend into the diffusion layer by extending into such pits or grooves on the surface facing the separator element. This can also be seen as the elongated nanostructures 311 being at least partially embedded in the diffusion layer.

As an example, the nanostructures may extend into the diffusion layer by more than 50% of their length. As another example, the nanostructures may extend into the diffusion layer by 90% of their length.

Porous materials can be characterized by their void fraction, i.e., the ratio of the volume of the voids or pores to the total volume of the material. A porous material comprised in a diffusion layer 320 may for example have a void fraction of 0.3 or more, or a void fraction above 0.5.

The plurality of elongated nanostructures creates close mechanical contact between the separator element and the diffusion layer. The close mechanical contact will lead to improved electrical contact and reduced contact resistance, particularly if the elongated nanostructures comprise an electrically conductive material. In this case, the physical contact between the elongated nanostructures and the diffusion layer also establishes an electrical connection with a low contact resistance between the elongated nanostructures 311 and the diffusion layer 320. As the elongated nanostructures 311 are connected to the separator element 310, this has the consequence of reducing the contact resistance between the separator element 310 and the diffusion layer 320. Preferably, the elongated nanostructures 311 should be arranged to be in contact with the material of the diffusion layer over a large fraction of their surface area. A large fraction of the surface area of the elongated nanostructures may be more than 50% of said surface area.

According to aspects, the separator element 310 is a planar element or plate. According to other aspects, the diffusion layer is also a planar element. A plate or planar element is extended in two dimensions and comparatively thin in the third dimension. The two dimensions in which such an element is extended define a plane of extension of the element.

Each planar element generally comprises two large bounding surfaces that are mostly parallel to the plane of extension, and that are typically the largest bounding surfaces of the element. These bounding surfaces can be referred to as a first and second side of the planar element. The separator element 310 and the diffusion layer 320 may be arranged so that a first side of the separator element 310 is adjacent to a first side of the diffusion layer 320, and the planes of extension of the separator element and diffusion layers may be generally parallel. The elongated nanostructures 311 may then be attached to the first side of the separator element 310 and pass beyond the surface of the first side of the diffusion layer 320.

The plurality of elongated nanostructures 311 may comprise elongated carbon nanostructures. Elongated carbon nanostructures could for example be any of carbon nanofibers, carbon nanowires, and carbon nanotubes.

Carbon materials are frequently used in electrochemical cells, e.g., as catalyst support and diffusion layer materials, due to their good electrical conductivity and chemical stability. In particular, carbon materials are used on both the anode and the cathode side in fuel cells and on the cathode side in electrolyzers. Due to their chemical stability, elongated carbon nanostructures have the advantage that non-conductive compounds are unlikely to form on the surface, which is advantageous for maintaining a low electrical contact resistance. The presence of carbon nanostructures on the surface of the separator element 310 may also prevent chemical degradation of the separator element itself by shielding the surface from the chemical environment of the cell.

The shape and structure of elongated carbon nanostructures can be altered by adjusting the conditions under which the nanostructures are grown, so as to obtain e.g., a desired density or shape of the nanostructures, a desired thickness or length of the nanostructures or a desired number of nanostructures per surface area. Carbon nanofibers and nanowires in particular have the advantage of a high stiffness and rigidity, making them less likely to be deformed if the fuel cell is assembled by a method such as pressing the components together, and more likely to remain in a desired orientation relative to the separator element 310.

The plurality of elongated nanostructures 311 may also comprise elongated metallic nanostructures, or nanostructures comprising any of copper, aluminum, silver, gallium arsenide, zinc oxide, indium phosphate, gallium nitride, indium gallium nitride, indium gallium arsenide, silicon, or other materials.

As previously mentioned, the elongated nanostructures are larger in one dimension than in other dimensions. Consider an axis along this dimension as the length axis of an elongated nanostructure, and the size of the nanostructure in this dimension as the nanostructure length. The size of the nanostructure in the other dimensions can be referred to as a nanostructure width or, for mostly cylindrical nanostructures, a nanostructure diameter.

The length axis of an elongated nanostructure also indicates the orientation of the nanostructure. For example, an elongated nanostructure can be said to be oriented perpendicular to the separator element 310 if the length axis extends perpendicularly or nearly perpendicularly to the plane of extension of the separator element 310, or equally if the length axis is parallel or nearly parallel with the normal vector of the plane of extension.

In order to connect the separator element and the respective diffusion layer, it is advantageous to have the elongated nanostructures oriented in a uniform direction.

At least some of the elongated nanostructures 311 may therefore be oriented in parallel to each other and extend along a direction perpendicular or substantially perpendicular to a plane of extension of the separator element 310.

This should not be taken to mean that the nanostructures are completely straight or completely perpendicular to the plane of extension of the separator element 310. The nanostructures may extend generally along a direction perpendicular to the plane of extension, which can be taken to mean that the nanostructures may have a moderate tilt relative to the normal vector of the plane of extension, or they may curve back and forth to form a spiraling or wavy shape. Rather, the nanostructures extend in the general direction of the normal vector. In this context, a moderate tilt may mean that the angle between the length axis of the elongated nanostructure and the normal vector of the plane of extension is less than 45 degrees, and preferably may be less than 30 degrees.

As an alternative, at least some of the elongated nanostructures 311 may extend at an angle to the normal of the plane of extension of the separator element 310. The angle between the length axis of an elongated nanostructure and the normal of the plane of extension may for example be in the range of 10 to 80 degrees. The angle may, e.g., depend on the properties of the diffusion layer, such as void fraction and pore size, or on a manufacturing method used to assemble the separator element arrangement 300.

According to aspects, the length axes of individual nanostructures may have different angles relative to the normal vector, such that not all elongated nanostructures in the plurality of elongated nanostructures are completely parallel to each other. As an example, an angle between the length axes of two elongated nanostructures may be less than 45 degrees, and preferably less than 30 degrees. As another example, an angle between the length axes of two elongated nanostructures may be equal to or more than 45 degrees.

The length and width of the elongated nanostructures may be adjusted depending on, e.g., the properties of the diffusion layer 320. As an example, the width of the elongated nanostructures may be adjusted to be smaller than a pore size of a porous material comprised in the diffusion layer. As another example, the nanostructure length may be adjusted so as to promote contact between the elongated nanostructures and the diffusion layer material, for example the nanostructure length may be similar to or larger than the pore size of the diffusion layer material. According to aspects, the length of at least one of the elongated nanostructures measured along an axis extending perpendicularly to a plane of extension of the separator element 310 may be between 10 and 20 micrometers.

In particular, the diffusion layer 320 may comprise a porous material comprising a plurality of fibers. Fibers are generally elongated structures larger in one dimension than the others. Their shape may therefore be characterized by a length in the dimension in which they are elongated and a thickness in each of the dimensions perpendicular to this elongation dimension. For largely cylindrical fibers the thickness may be a fiber diameter. If the thickness is not constant along the length of the fiber, the thickness may be an average thickness. The length of the elongated nanostructures may be adapted to the thickness of the fibers comprised in the porous material in order to increase mechanical and electrical contact between the fibers and the elongated nanostructures. As an example, the elongated nanostructures may have a length similar to or larger than an average thickness of the fibers.

The spacing between elongated nanostructures in the plurality of elongated nanostructures 311 may also be adapted to the structure of a porous material comprised in the diffusion layer 320. For example, the spacing may be adapted to an average spacing between the pores in the porous material. If the porous material comprises fibers, the spacing may be at least as large as the thickness of said fibers.

The orientation of a fiber is generally taken to be the direction of its elongation dimension. According to one example, if the porous material comprised in the diffusion layer 320 comprises fibers, these fibers may be oriented randomly to form a felted or paper-like material such as carbon felt or graphite felt. According to another example, the fibers may follow two main directions of orientation largely perpendicular to each other, as in a woven fabric.

The plurality of fibers comprised in the porous material may be oriented generally in parallel to a plane of extension of the separator element 310. This can be taken to mean that a majority of the fibers are oriented at an angle of less than 45 degrees to the plane of extension, and preferably oriented at an angle of less than 30 degrees to the plane of extension. If the elongated nanostructures comprised in the separator element 310 are oriented generally perpendicularly to the plane of extension, the elongated nanostructures and the fibers comprised in the porous material may be generally perpendicular to each other. The elongated nanostructures can then more easily extend into the spaces between the fibers comprised in the porous material, and also maintain contact with the fibers comprised in the porous material along the length of the elongated nanostructures. This can improve mechanical and electrical contact between the separator element 310 and the diffusion layer 320.

As an example, the plurality of fibers comprised in the porous material may have thicknesses between 1 and 10 micrometers. As another example, the plurality of fibers may be nanofibers or nanotubes.

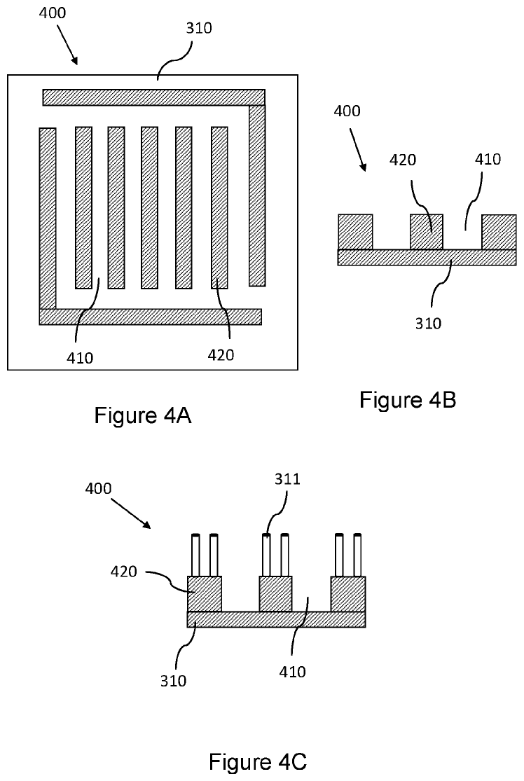

According to aspects, the diffusion layer 320 may comprise a porous carbon material. The porous carbon material may comprise a plurality of carbon fibers, which may extend generally parallel to a plane of extension of the separator element 310 and/or generally perpendicularly to the plurality of elongated nanostructures 311. Separator elements used in electrochemical cells often comprise flow field arrangements that are used to promote an even distribution of reactants across the separator element, as well as facilitating the removal of reaction products. A schematic of an example flow field arrangement is shown in FIGS. 4A and B. The flow field arrangement 400 comprises a plurality of grooves, known as flow channels 410, separated by ridges known as ribs or channel supports 420. Gases and liquids can flow along the flow channels 410 and thus be spread out over the entire separator element. As an example, the flow field arrangement may be formed by creating indentations in the separator element 310 to form the flow channels 410. As another example, the flow field arrangement may be formed by depositing a material on the surface of the separator element 310 to form the channel supports 420.

When the separator element is a planar element, the flow field arrangement is generally arranged on the first and second sides described above, that is, on the surfaces of the element that are parallel with the plane of extension of the element. In the separator element arrangement as described herein, the flow field may be arranged on the surface of the separator element facing the diffusion layer. If the separator element is a bipolar plate used in a stack of electrochemical cells, two flow field arrangements may be arranged on opposite sides of the separator element.

The type of flow field arrangement 400 shown in FIGS. 4A and 4B is known as a straight parallel flow field arrangement, due to the placement of the ribs promoting a parallel flow of gases and/or liquids through neighboring channels. Other flow field arrangement designs may also be used, such as serpentine, interdigitated, or pin-type flow field arrangements.

Thus, at least one of the separator elements may comprise a flow field arrangement 400. The flow field arrangement 400 may be arranged on a surface of the separator element 310 facing the diffusion layer 320. It can comprise a plurality of flow channels 410 separated by a plurality of channel supports 420, wherein the flow channels 410 are arranged to promote an even distribution of a gas and/or a liquid across the flow field arrangement 400.

Since the channel supports 420 form elevated sections, ridges, or bumps in the surface of the separator element, they will be in closer contact with the adjacent diffusion layer. Therefore, the plurality of elongated nanostructures 311 may be connected to a surface of at least one of the channel supports 420 of the flow field arrangement 400. The surface to which the elongated nanostructures 311 are connected will then be a surface that faces the diffusion layer 320. This is illustrated in FIG. 4C.

The chemical environment in an electrochemical cell can cause corrosion and/or degradation of some materials. Although carbon materials are generally sufficiently chemically stable for use in fuel cells and on the cathode side in electrolyzers, they may require additional surface treatment for use e.g., on the anode side in electrolyzers. Other materials used in separator elements, such as stainless steel, may also require additional treatment in order to tolerate the environment in the electrochemical cell. Thus, the separator element 310 may comprise a protective coating arranged to increase a resistance to corrosion. As an example, the protective coating may comprise any of platinum, gold, or titanium, or a combination thereof. As another example, the protective coating may comprise ceramic materials or metal oxides such as aluminum oxide, cerium oxide and zirconium oxide. The protective coating may also comprise carbon-based materials. The protective coating may cover all or part of the separator element 310.

With reference to FIGS. 6 and 3, there is also disclosed a method for producing a separator element arrangement 300 comprising a separator element 310 and a diffusion layer 320 arranged adjacent to the separator element. The method comprises generating S1 a plurality of elongated nanostructures 311, the elongated nanostructures 311 being attached to a surface of the separator element 310. The method also comprises arranging S2 the diffusion layer 320 adjacent to the separator element 310 such that the elongated nanostructures 311 connect the separator element 310 to the diffusion layer 320 by extending into the diffusion layer 320. A plurality of elongated nanostructures 311 may be generated through lithographic methods such as colloidal lithography or nanosphere lithography, focused ion beam machining and laser machining, among other methods. For nanofibers comprising carbon or organic compounds, methods such as electrospinning or chlorination of carbides such as titanium carbide or metalorganic compounds such as ferrocene may also be used.

Generating S1 a plurality of elongated nanostructures 311 may comprise growing S11 the elongated nanostructures 311 on a substrate. Growing S11 elongated nanostructures 311 on a substrate allows extensive tailoring of the properties of the nanostructures, including the height of the nanostructures, as well as of the spacing between nanostructures. According to aspects, the elongated nanostructures may be grown by plasma-enhanced chemical vapor deposition.

The substrate may comprise materials such as silicon, glass, stainless steel, ceramics, silicon carbide, or any other suitable substrate material. The substrate may also comprise high temperature polymers such as polymide. Optionally, the substrate may be a component for an electrochemical cell, preferably a separator element 310. Growing S11 the elongated nanostructures 311 on a substrate may comprise depositing a growth catalyst layer on a surface of the substrate and growing the elongated nanostructures 311 on the growth catalyst layer.

Herein, a growth catalyst is a substance that is catalytically active and promotes the chemical reactions comprised in the formation of nanostructures.

The growth catalyst may comprise materials such as nickel, iron, platinum, palladium, nickel-silicide, cobalt, molybdenum, gold, or alloys thereof. As an example, the growth catalyst layer may be between 1 and 100 nm thick. As another example, the growth catalyst layer may comprise a plurality of particles of growth catalyst.

Growing S11 the elongated nanostructures 311 on the growth catalyst layer may comprise heating the growth catalyst layer to a temperature where nanostructures can form and providing a gas comprising a reactant in such a way that the reactant comes into contact with the growth catalyst layer. Here, the reactant is a chemical compound or mix of chemical compounds that comprises the chemical elements used to form the nanostructure. For a carbon nanostructure, the reactant may comprise a hydrocarbon such as methane or acetylene, or it may comprise carbon monoxide.

Depositing a growth catalyst layer may comprise depositing a uniform growth catalyst layer and introducing a pattern onto the deposited uniform growth catalyst layer. Introducing a pattern onto the deposited uniform growth catalyst layer could comprise altering the thickness of the growth catalyst layer according to a pattern, or selectively removing the growth catalyst layer in some places. Introducing a pattern onto the growth catalyst layer may for example be accomplished through lithographic methods such as colloidal or nanosphere lithography. The patterning of the growth catalyst layer makes it possible to control the number of nanostructures per surface area on the substrate.

The method may also comprise depositing a conducting layer on a surface of the substrate. The growth catalyst layer may then be deposited on top of the conducting layer. After growing the elongated nanostructures, parts of the conductive layer that extend between or around the elongated nanostructures may be selectively removed. This removal may for example be accomplished through etching, e.g., plasma etching, pyrolysis etching or electrochemical etching.

The conducting layer electrically grounds the substrate, which is an advantage for certain methods of nanostructure growth such as growth in a plasma. It may also prevent the diffusion of atoms between the growth catalyst layer and the substrate.

According to aspects, the conducting layer may be between 1 and 100 microns thick. According to other aspects, the conducting layer may be between 1 and 100 nm thick.

According to aspects, additional layers may be present in addition to the substrate, the growth catalyst layer, and the conducting layer. The materials comprised in the additional layers may be selected to tune properties of the grown nanostructures, facilitate vertically oriented growth, or otherwise improve the result of the growth process. The additional layers may also comprise a separator element 310 for an electrochemical cell.

According to aspects, depositing any layer including the conducting layer and the growth catalyst layer may be carried out by methods such as evaporating, plating, sputtering, molecular beam epitaxy, pulsed laser depositing, chemical vapor deposition, spin-coating, spray-coating, or other suitable methods.

According to aspects, the elongated nanostructures may be grown on a substrate comprising a component for an electrochemical cell, preferably a separator element 310. According to other aspects, the elongated nanostructures may be grown on some other substrate and subsequently transferred onto a separator element 310. Optionally, an additional surface treatment or conditioning may be used on the elongated nanostructures after growth. A surface treatment may e.g., aim to improve a resistance to corrosion, improve a wettability of the surface of the nanostructures, decrease a surface resistivity of the nanostructures, or to achieve some other advantageous effect. The surface treatment may comprise the deposition of a substance on the surface of the nanostructures, e.g., through evaporating, plating, sputtering, molecular beam epitaxy, pulsed laser depositing, chemical vapor deposition, spin-coating, spray-coating, or other suitable methods. The surface treatment may also comprise chemical treatments such as etching or functionalization.

The method may also comprise coating S12 at least one of the separator elements at least partly with a protective coating arranged to increase a resistance to corrosion. The protective coating may for example comprise materials such as gold, platinum or titanium and may be deposited through evaporating, plating, sputtering, molecular beam epitaxy, pulsed laser depositing, chemical vapor deposition, spin-coating, spray-coating, or other suitable methods.

With reference to FIGS. 1 and 3, there is also herein disclosed a fuel cell 100 comprising an ion exchange membrane 130, a first electrocatalyst layer 111, and a second electrocatalyst layer 121. The first and second electrocatalyst layers 111, 121 are arranged adjacent to the ion exchange membrane on either side of the ion exchange membrane. The fuel cell further comprises a first separator element arrangement 110 and a second separator element arrangement 120 arranged adjacent to the respective first and second electrocatalyst layers 111, 121 on the side of the respective electrocatalyst layer facing away from the ion exchange membrane 130. Each separator element arrangement comprises a separator element 310 and a diffusion layer 320 arranged adjacent to the separator element. At least one of the separator element arrangements 110, 120 is a separator element arrangement as previously described herein. That is, a separator element arrangement also comprising a plurality of elongated nanostructures 311 attached to a surface of the separator element 310, at least some of the elongated nanostructures being arranged to connect the separator element 310 to the respective diffusion layer 320 by extending into the respective diffusion layer 320, as previously described. In the fuel cell, each separator element arrangement is arranged so that the diffusion layer 320 is sandwiched between the separator element and the adjacent electrocatalyst layer.

The ion exchange membrane 130, electrocatalyst layers 111, 121, diffusion layers 320, and separator elements 310 may be mostly planar elements as defined earlier. Thus, if the first and second electrocatalyst layers 111, 121 are arranged on either side of the ion exchange membrane 130, this can be interpreted as the first electrocatalyst layer 111 being placed near the first side and the second electrocatalyst layer 121 being placed near the second side of the ion exchange membrane, such that the two electrocatalyst layers are separated by the ion exchange membrane 130 and the planes of extension of the ion exchange membrane 130, the first electrocatalyst layer 111, and the second electrocatalyst 121 are largely parallel.

In other words, the fuel cell may be described a stack of mostly planar elements, where the stack comprises in order a first separator element, a first diffusion layer, the first electrocatalyst layer 111, the ion exchange membrane 130, the second electrocatalyst layer 121, a second diffusion layer, and a second separator element. The first separator element and the first diffusion layer together form the first separator element arrangement 110, and the second separator element and the second diffusion layer form the second separator element arrangement 120.

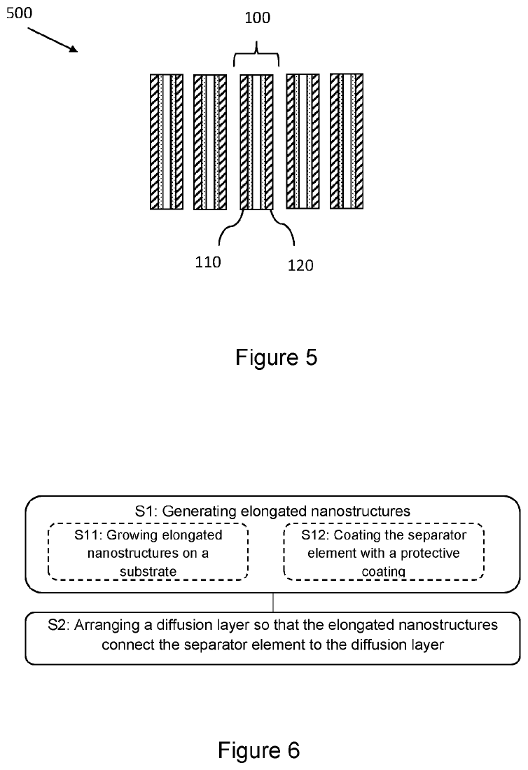

Fuel cells are frequently arranged in stacks with several cells connected in series, as illustrated in FIG. 5. Therefore, there is also herein disclosed a fuel cell stack 500 comprising at least one fuel cell 100 as described above. The fuel cell stack 500 may also comprise one or more fuel cells that do not comprise a separator element arrangement as herein described, or it may comprise multiple fuel cells 100 as described above.

There is also herein disclosed, with reference to FIGS. 2 and 3, an electrolyzer 200 comprising an ion exchange membrane 230, a first electrocatalyst layer 211, and a second electrocatalyst layer 221. The first and second electrocatalyst layers 211, 221 are arranged adjacent to the ion exchange membrane 230 on either side of the ion exchange membrane. The electrolyzer further comprises a first separator element arrangement 210 and a second separator element arrangement 220 arranged adjacent to the respective first and second electrocatalyst layers 211, 221 on the side of the respective electrocatalyst layer facing away from the ion exchange membrane 230. Each separator element arrangement comprises a separator element 310 and a diffusion layer 320 arranged adjacent to the separator element.

At least one of the separator element arrangements 210, 220 is a separator element arrangement as previously described herein. That is, at least one separator element arrangement comprises a plurality of elongated nanostructures 311, the elongated nanostructures being attached to a surface of the separator element 310, at least some of the elongated nanostructures being arranged to connect the separator element 310 to the respective diffusion layer 320 by extending into the respective diffusion layer 320. In the electrolyzer, each separator element arrangement is arranged so that the diffusion layer 320 is sandwiched between the separator element 310 and the adjacent electrocatalyst layer.

The ion exchange membrane 230, electrocatalyst layers 211, 221, diffusion layers 320, and separator elements 310 may be mostly planar elements as defined earlier. Thus, if the first and second electrocatalyst layers 211, 221 are arranged on either side of the ion exchange membrane 230, this can be interpreted as the first electrocatalyst layer 211 being placed near the first side of the ion exchange membrane 230 and the second electrocatalyst layer 221 being placed near the second side of the ion exchange membrane 230, such that the two electrocatalyst layers are separated by the ion exchange membrane 230 and the planes of extension of the ion exchange membrane 230, the first electrocatalyst layer 211, and the second electrocatalyst 221 are largely parallel.

In other words, the electrolyzer may be described a stack of mostly planar elements, where the stack comprises in order a first separator element, a first diffusion layer, the first electrocatalyst layer 211, the ion exchange membrane 230, the second electrocatalyst layer 221, a second diffusion layer, and a second separator element. The first separator element and the first diffusion layer together form the first separator element arrangement 210, and the second separator element and the second diffusion layer form the second separator element arrangement 220.

There is also disclosed an electrolyzer stack comprising at least one electrolyzer as described above. The electrolyzer stack may also comprise one or more electrolyzers that do not comprise a separator element arrangement as herein described, or it may comprise multiple electrolyzers 100 as described above.

1. A separator element arrangement for an electrochemical cell, the separator element arrangement comprising a separator element and a diffusion layer arranged adjacent to the separator element, the separator element comprising a plurality of elongated nanostructures, at least some of the elongated nanostructures being arranged to connect the separator element to the diffusion layer by extending into the diffusion layer.

2. The separator element arrangement according to claim 1, wherein the separator element is a planar element.

3. The separator element arrangement according to claim 1, wherein the plurality of elongated nanostructures comprises elongated carbon nanostructures.

4. The separator element arrangement according to claim 3, wherein the elongated carbon nanostructures comprise any of carbon nanofibers, carbon nanowires, and carbon nanotubes.

5. The separator element arrangement according to claim 1, wherein the plurality of elongated nanostructures comprises elongated metallic nanostructures.

6. The separator element arrangement according to claim 1, wherein at least some of the elongated nanostructures are oriented in parallel to each other and extend along a direction perpendicular to a plane of extension of the separator element.

7. The separator element arrangement according to claim 6, wherein a length of at least one of the elongated nanostructures measured along an axis extending perpendicularly to a plane of extension of the separator element is between 10 and 20 micrometers.

8. The separator element arrangement according to claim 1, wherein the separator element comprises a flow field arrangement, the flow field arrangement being arranged on a surface of the separator element facing the diffusion layer, the flow field arrangement comprising a plurality of flow channels separated by a plurality of channel supports, wherein the flow channels are arranged to promote an even distribution of a gas and/or a liquid across the flow field arrangement.

9. The separator element arrangement according to claim 8, wherein the plurality of elongated nanostructures is connected to a surface of at least one of the channel supports of the flow field arrangement, and where the surface faces the diffusion layer.

10. The separator element arrangement according to claim 1, wherein the separator element comprises a protective coating arranged to increase a resistance to corrosion.

11. The separator element arrangement according to claim 1, wherein the diffusion layer comprises a porous carbon material.

12. The separator element arrangement according to claim 11, wherein the porous carbon material comprises a plurality of carbon fibers, the plurality of carbon fibers extending generally parallel to a plane of extension of the separator element and/or generally perpendicularly to the plurality of elongated nanostructures.

13. A method for producing a separator element arrangement, the separator element arrangement comprising a separator element and a diffusion layer arranged adjacent to the separator element, the method comprising:
generating a plurality of elongated nanostructures, the elongated nanostructures being connected to a surface of the separator element; and
arranging the diffusion layer adjacent to the separator element such that the elongated nanostructures connect the separator element to the diffusion layer by extending into the diffusion layer.

14. The method according to claim 13, wherein generating a plurality of elongated nanostructures comprises growing the elongated nanostructures on a substrate.

15. The method according to claim 14, where growing the elongated nanostructures on a substrate comprises depositing a growth catalyst layer on a surface of the substrate and growing the elongated nanostructures on the growth catalyst layer.

16. The method according to claim 15, where depositing a growth catalyst layer comprises depositing a uniform growth catalyst layer and introducing a pattern onto the deposited uniform growth catalyst layer.

17. The method according to claim 14, comprising depositing a conducting layer on a surface of the substrate.

18. The method according to claim 13, comprising coating the separator element at least partly with a protective coating arranged to increase a resistance to corrosion.

19. A fuel cell comprising an ion exchange membrane, a first electrocatalyst layer, and a second electrocatalyst layer, the first and second electrocatalyst layers being arranged adjacent to the ion exchange membrane on either side of the ion exchange membrane, the fuel cell further comprising a first separator element arrangement and a second separator element arrangement arranged adjacent to the respective first and second electrocatalyst layers on the side of the respective electrocatalyst layer facing away from the ion exchange membrane, each separator element arrangement comprising a separator element and a diffusion layer arranged adjacent to the separator element, wherein at least one of the separator element arrangements is a separator element arrangement according to claim 1.

20. A fuel cell stack comprising at least one fuel cell according to claim 19.

21. An electrolyzer comprising an ion exchange membrane, a first electrocatalyst layer, and a second electrocatalyst layer, the first and second electrocatalyst layers being arranged adjacent to the ion exchange membrane on either side of the ion exchange membrane, the electrolyzer further comprising a first separator element arrangement and a second separator element arrangement arranged adjacent to the respective first and second electrocatalyst layers on the side of the respective electrocatalyst layer facing away from the ion exchange membrane, each separator element arrangement comprising a separator element and a diffusion layer arranged adjacent to the separator element, wherein at least one of the separator element arrangements is a separator element arrangement according to claim 1.

22. An electrolyzer stack comprising at least one electrolyzer according to claim 21.
